(19) United States
(12) Patent Application Publication
(10) Pub. No.: US 2005/0272472 A1
(43) Pub. Date: Dec. 8, 2005

(54) Wireless communication method and system for forming three-dimensional control channel beams and managing high volume user coverage areas

(75) Inventors: Steven Jeffrey Goldberg, Downingtown, PA (US); Fatih Ozluturk, Port Washington, NY (US); Jung-Lin Pan, Selden, NY (US); Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/019,422

(22) Filed: Dec. 22, 2004

Related U.S. Application Data
(60) Provisional application No. 60/574,785, filed on May 27, 2004.
(60) Provisional application No. 60/633,513, filed on Dec. 6, 2004.

(51) Int. Cl. H04Q 7/20

(52) U.S. Cl. 455/562.1; 455/446

(57) ABSTRACT

A wireless communication system and method generates and shapes one or more three-dimensional control channel beams for transmitting and receiving signals. Each three-dimensional beam is directed to cover a particular coverage area and beam forming is utilized to adjust bore sight and beam width of the three-dimensional beam in both azimuth and elevation, and the three-dimensional control channel beam is identified. In another embodiment, changes in hot-zones or hot-spots, (i.e., designated high volume user coverage areas), are managed by a network cell base station having at least one antenna. Each of a plurality of wireless transmit/receive units (WTRUs) served by the base station use a formed beam based on one or more beam characteristics. When the coverage area is changed, the base station instructs at least one of the WTRUs to change its beam characteristics such that it forms a return beam concentrated on the antenna of the base station.

### CROSS REFERENCE TO RELATED APPLICATION

This application claims priority from U.S. provisional Patent Application Ser. Nos. 60/574,785, filed May 27, 2004 and 60/633,513, filed Dec. 6, 2004, which are incorporated by reference as if fully set forth.

### FIELD OF THE INVENTION

The present invention relates to a wireless communication system. More particularly, the present invention relates to implementing smart antenna beam coverage in both azimuth and elevation planes to provide enhanced wireless services in a concentrated coverage area by forming and directing three-dimensional control channel beams.

### BACKGROUND

Conventional wireless communication systems usually operate in two states. One is the common channel state utilized to provide initial contact and ongoing overall control of the communications means. The other is the data state, during which data is exchanged. The systems have different functions, and thus have different coverage, capacity, availability, reliability and data rate requirements. Improvements to one or more of these characteristics would be beneficial.

The U.S. Pat. No. 6,785,559 entitled “System For Efficiently Covering A Sectorized Cell Utilizing Beam Forming And Sweeping,” issued on Aug. 31, 2004 to Goldberg et al., which is incorporated by reference in its entirety herein, discloses an efficient means for providing control channel coverage.

Sectoring is a well known technique for providing distinct coverage areas from individual cell sites and can be achieved with “smart antenna” technology, which is well known in the art. Smart antenna methods dynamically change the radiation pattern of an antenna to form a “beam,” which focuses the antenna's topographical coverage.

Beam forming is an enhancement on sectoring in that the sectors can be adjusted in direction and width. Both techniques are employed to: 1) reduce interference between cells and wireless transmit/receive units (WTRUs) deployed within the cells; 2) increase the range between a receiver and a transmitter; and 3) locate a WTRU. These techniques are usually applied to the dedicated channels of the WTRUs once their general location is known.

Prior to knowing the location of a WTRU, the common channels broadcast information that all WTRUs may receive. While this information may be sent in static sectors, it is not sent in variable beams. There are inherent inefficiencies in this approach in that extra steps are required to determine the appropriate beam to use for the dedicated data exchanges. Additionally, the beams must be generally large enough to provide a broad coverage area, which in turn means their power with distance from the transmitter is lower. In such cases, they must use higher power, have longer symbol times and/or more robust encoding schemes to cover the same range.

Common channel coverage using a prior art scheme is shown in FIG. 1 as four overlapping wide beams produced by a base station (BS). This provides omni-directional coverage, while giving a degree of reuse to the cell site. It also provides a coarse degree of directivity to the WTRUs (WTRU1, WTRU2) detecting one of the transmissions, by having each sector transmit a unique identifier.

Referring to FIG. 2, downlink dedicated beams between a BS and several WTRUs (UE3, UE4) are shown. Assuming the same power from the BS for FIGS. 1 and 2 and all other attributes being equal, the WTRUs (WTRU3 and WTRU4) shown in FIG. 2 can be further away from the BS than the WTRUs (WTRU1, WTRU2) shown in FIG. 1. Alternatively, the coverage areas can be made approximately the same by decreasing the symbol rate and/or increasing the error correction coding. Either of these approaches decreases the data delivery rate. This also applies to the receiver uplink beam patterns of the BS; and the same comments about coverage and options apply for data from the WTRUs to the BS.

In the prior art, the range of a BS or a WTRU is generally increased by combinations of higher power, lower symbol rates, error correction coding and diversity in time, frequency or space. However, these methods yield results that fall short of optimized operation. Additionally, there is a mismatch between the common and dedicated communications channels in the ways that coverage is aligned.

Referring to FIG. 3, the dashed outlines represent possible positions P.sub.1-P.sub.n for a common channel beam B emanating from a BS. At a particular time period, the beam B exists only in one of the positions P.sub.1 as illustrated by the solid outline. The arrow shows the time sequencing of the beam B. In this illustration, the beam B sequentially moves from one clockwise position P.sub.1 to another P.sub.2-P.sub.n, although a clockwise rotation is not necessary.

The system provides for identifying the beam B at each of the positions P.sub.1-P.sub.n. A first embodiment for identifying the beam B is to send a unique identifier while the beam B is at in each position P.sub.1-P.sub.n. For example, at a first position P.sub.1 a first identifier I.sub.1 will be transmitted, at a second position P.sub.2 a second identifier I.sub.2 will be generated, and so on for each of the positions P.sub.1-P.sub.n. If the beam B is swept continuously, a different identifier I.sub.1-I.sub.m may be generated for each degree, (or preset number of degrees), of rotation.

Another prior art method for identifying the position P.sub.1-P.sub.n of the beam B is to use a time mark as a type of identifier, which the WTRU returns to the BS. Returning either the time mark (or the identifier) to the BS informs the BS which beam B was detected by the WTRU. For that time period, the BS now knows the position P.sub.1-P.sub.n of the beam B that was able to communicate with the WTRU. However, it should be noted that due to possible reflections, this is not necessarily the direction of the WTRU from the BS.

Another prior art method for identifying the position P.sub.1-P.sub.n of the beam B is to use time-synchronization. The beam B is positioned and correlated with a known time mark. One way of achieving this would be for both the WTRUs and the BS to have access to the same time reference, such as the global positioning system (GPS), National Institute of Standards and Technology (NIST) internet time or radio time broadcasts (WWV) or local clocks with adequate synchronization maintained.

Another prior art method for identifying the position P.sub.1-P.sub.n of the beam B is for the WTRUs and the BS to synchronize to timing marks coming from the infrastructure transmissions. The WTRUs can detect beam transmissions identifying the BS, but not necessarily the individual beam B positions P.sub.1-P.sub.n. By the WTRU reporting back to the BS the time factor when it detected the beam B, the BS can determine which beam B the WTRU is referencing. The benefit of this embodiment is that the common channel transmission does not have to be burdened with extra data to identify the position P.sub.1-P.sub.n of the beam B.

Another prior art method for identifying the position of the beam B is to incorporate a GPS receiver within the WTRU. The WTRU can then determine its geographical location by latitude and longitude and report this information to the BS. The BS can then use this information to precisely generate the direction of the beam B, beam width and power. Another advantage of this method is the precise location obtained of the WTRU, which will allow users to locate the WTRU if the need arises.

Referring to FIG. 4, the location pattern may be tailored as desired by the system administrator. In this manner, the BS may position the beam B in a pattern consistent with the expected density of WTRUs in a particular area. For example, a wide beam W.sub.1, W.sub.2, W.sub.3 may be cast in positions P.sub.1, P.sub.2, P.sub.3, respectively, with few WTRUs, and more narrow beams N.sub.4, N.sub.5, N.sub.6 cast in positions P.sub.4, P.sub.5, P.sub.6, respectively, with many WTRUs. This facilitates the creation of narrower dedicated beams B in the denser areas, and also increases the capacity for the uplink and downlink use of the common channels to establish initial communications.

The beam width manipulation is preferably performed in real time. However, the conditions of communication and the nature of the application determine the suitability of number of beam positions P.sub.1-P.sub.n and their associated beam width patterns. The beam patterns formed should be sufficiently wide such that the number of WTRUs entering and leaving the beam can be handled without excessive handoff to other beams. A static device can be serviced by a narrow beam. Swiftly moving cars for example, could not be serviced effectively by a narrow beam perpendicular to the flow of traffic, but could be serviced by a narrow beam parallel to the direction of travel. A narrow perpendicular beam would only be adequate for short message services, not for voice services, such as phone calls.

Another advantage to using different beam widths is the nature of the movement of WTRUs within a region. Referring to FIG. 5, a building BL is shown (representing an area having primarily slower moving pedestrian-speed devices WTRU.sub.s), and a highway H is shown, (representing an area having primarily faster moving devices WTRU.sub.f). The slower speed devices WTRU.sub.s can be served by narrow beams N.sub.1-N.sub.3 that are likely to be traversed during a communication time period. Alternatively, the faster moving devices WTRU.sub.f require wider beams W.sub.1-W.sub.3 to support a communication.

Beam width shaping also decreases the frequency of handover of WTRUs from one beam B to another. Handover requires the use of more system resources than a typical communication since two independent communication links are maintained while the handover is occurring. Handover of beams also should be avoided because voice communications are less able to tolerate the latency period often associated with handover.

Data services are packet size and volume dependent. Although a few small packets may be transmitted without problems, a large packet requiring a significant number of handovers may utilize excessive bandwidth. This would occur when links are attempted to be reestablished after a handover. Bandwidth would also be used up when multiple transmissions of the same data is sent in an attempt to perform a reliable transfer.

Downlink common channel communication will often be followed by uplink transmissions. By knowing the transmission pattern of the BS, the WTRU can determine the appropriate time to send its uplink transmission. To perform the necessary timing, a known fixed or broadcast time relationship is utilized. In the case of a fixed relationship, the WTRU uses a common timing clock. The WTRU waits until a predetermined time in which the BS has formed a beam over the WTRU's sector before transmitting. In the case of a broadcast, the BS informs the WTRU when to send its uplink signal. The uplink and downlink beam forming may or may not overlap. It is often an advantage to avoid overlap, so that a device responding to a transmission can respond in less time than would be required to wait an entire antenna beam forming timing cycle for the same time slot to occur.

It should be noted that code division multiple access (CMDA) and other radio frequency (RF) protocols utilize some form of time division. When responding to these types of temporal infrastructures, both beam sectoring and the time slots of the protocol would be of concern. Other non-time dependent RF protocols, such as slotted Aloha would only involve sectoring.

The prior art methods are directed to “sweeping” the beam B around a BS in a sequential manner. In many instances, this is typically the most convenient way to implement the methods. There are, however, alternative ways to assume the various positions. For instance, it may be desirable to have more instances of coverage in certain areas. This could be done generating the beam in a sequence of timed positions. For instance, if there are 7 positions, (numbered 1 through 7), a sequence of (1, 2, 3, 4, 2, 5, 6, 2, 7, 1) could be used. This would have the area covered by beam position number 2 more often than other positions, but with the same dwell time. It might also be desirable to have a longer dwell time in a region. The sequence (1, 2, 3, 4, 4, 5, 6, 7, 1) for instance would have beam position number 4 remain constant for two time periods. Any suitable sequencing could be utilized and modified as analysis of the situation warranted.

Likewise, it is not necessary to restrict the beam positions to a rotating pattern. The beam positions could be generated in any sequence that serves the operation of the communication system. For example, a pattern that distributed the beams B over time such that each quadrant was covered by at least one beam B might be useful for WTRUs that are closer to the PS and are likely to be covered by more than one beam position.

It should be noted that similar to all RF transmissions, an RF signal only stops at a physical point if there is a Faraday-type of obstruction, (e.g. grounded metal roof). Usually the signal dies off, and the boundary is some defined attenuation value from the peak value of the transmission. To provide adequate coverage in the application of this invention, it is preferable that adjacent beam positions overlap to some degree. The overlap will tend to be more pronounced closer to the transmission and reception antennas. Close to an infrastructure antenna site, any WTRU is therefore likely able to communicate via a number of differently positioned beams B. Devices able to communicate via several beam positions could therefore, if needed, achieve higher data rates using these multiple positions. Devices further away, however, are more likely to be able to communicate via only once instant of beaming, and to obtain higher data rates would require another technique such as a longer dwell time.

While the present technology of wireless communications has been successful in reducing interference endured by WTRUs through the expansion of network capacity and enhancement of coverage, further improvements in the WTRUs themselves is desirable.

Smart antennas provide several major benefits for wireless communication systems including improved multipath management, system capacity and robustness to system perturbations. Smart antennas use a beaming forming technique to reduce interference or improve multipath diversity in the wireless communication systems.

There are several beaming forming options for smart antennas, such as fixed beaming forming, switched beam forming and adaptive beam forming. FIG. 6 provides an example of a conventional wireless smart antenna communication system using adaptive beam forming. One major advantage of using smart antennas is to reduce interference.

Due to the supporting mobility in a cellular environment, the techniques used by smart antennas have failed to adequately track subscribers, thus degrading system performance and increasing the number of management tasks required to be performed by the wireless communication system. Also, the demand on “hot-spots” co-existing in the system has increased, as illustrated in FIG. 7, and each subscriber within same “hot-spot” may have different quality of service (QoS) requests, as illustrated in FIG. 8.

If a plurality of hot-spots co-exist in the same wireless communication system using a traditional smart antenna, a substantial amount of close beamforming must be assigned to those users that are geographically in close proximity to one another. Thus, the performance of the smart antenna may be degraded.

If there are multiple users located at the same hot-spot at the same time, and each user has a different QoS request, it is difficult for a conventional smart antenna to assign or reassign beamforming to serve the different QoS requests without causing cross interference between the users located at the same hot spot.

In a conventional wireless communication system, smart antennas are also used to create sectors in a cellular coverage area. As shown in FIG. 9, these sectors S1, S2, S3, S4, are essentially angular slices in the coverage area 900 extending from a base station.

In a conventional wireless communication system, location services currently make use of azimuth information. For example, information regarding where a signal is coming from in the horizontal orientation is detected and reported. This information can be extracted from a smart antenna configuration and used in reporting location. Conventional wireless systems make use of elevation information, (i.e., where a signal is coming from in the vertical orientation), in order to identify a location more precisely.

Hot zones and hot spots are those locations in a wireless system where there is a high concentration of users and data usage. Conventional wireless systems use a smart antenna to serve these hot zones and hot spots by forming and directing their beams in that direction. These hot zones and hot spots are defined as angular slices of the area that the smart antenna serves. Thus, as shown in FIG. 10, the hot zones and hot spots are only represented in terms of their horizontal orientation.

In a conventional wireless communication system, networks nodes that are equipped with smart antennas that communicate with each other by directing their signals to the appropriate direction without any adjustment for the vertical beam angle. Therefore, the transmissions are sent in angular slices in space and can reach and interfere with other nodes.

The conventional wireless communication systems described above are restricted to azimuth for adjusting control channel beams which, in many cases, is a suboptimum implementation.

### SUMMARY

The present invention is related to a wireless communication system and method for transmitting and receiving communications between at least one base station and at least one WTRU by providing one or more three-dimensional control channel beams. The system includes means for generating and shaping at least one three-dimensional control channel beam, an antenna for transmitting and receiving signals within the at least one three-dimensional control channel beam, means for directing the at least one three-dimensional control channel beam to cover a particular coverage area, wherein beam forming is utilized to adjust bore sight and beam width of the at least one three-dimensional control channel beam in both azimuth and elevation, and means for identifying the at least one three-dimensional control channel beam.

The antenna receives and transmits a communication. The means for generating and shaping shapes the at least one three-dimensional control channel beam into one of a plurality of selectable widths, from a wide width to a narrow width. The coverage area coincides with one or more sectors of a cell. The cell sectors are different sizes and the generating and shaping means shapes the three-dimensional control channel beam to cover the cell sectors, the sectors being identified by the means for identifying.

The means for generating and shaping shapes a plurality of three-dimensional control channel beams, and the means for directing selectively directs the shaped three-dimensional control channel beams in azimuth and elevation in a predetermined consecutive sequence.

The means for generating and shaping shapes a plurality of three-dimensional control channel beams, and the means for directing selectively directs the shaped three-dimensional control channel beams in azimuth and elevation in a predetermined non-consecutive sequence.

The non-consecutive sequence causes the means for directing to selectively direct the beam toward one of azimuth and elevation more frequently than the other one of azimuth and elevation.

The non-consecutive sequence causes the means for directing to selectively direct the beam toward one of azimuth and elevation for a longer duration than the other one of azimuth and elevation.

The means for identifying the three-dimensional control channel beam includes means for providing a unique identifier for the three-dimensional control channel beam.

The means for identifying the three-dimensional control channel beam includes means for transmitting a time mark to the WTRU, whereby the WTRU returns an indication of the received time mark, as detected by the WTRU, to the base station.

The means for identifying the three-dimensional control channel beam includes a time reference accessed by both the WTRU and the base station. The system may further comprise a position reporting circuit to provide a position location of the WTRU, the base station using the position location to identify at least one beam direction for the WTRU.

In yet another embodiment, the present invention is related to a wireless communication system and method for compensating for changes in one or more designated high volume user coverage areas. The system comprises a base station and a plurality of WTRUs which communicate with the base station using a three-dimensional control channel beam formed based on one or more beam characteristics. The base station includes at least one antenna. The base station uses the antenna to concentrate transmission and reception resources therein on at least one high volume user coverage area for serving users of the WTRUs. The base station modifies the coverage area and conveys instructions to at least one of the WTRUs to change its beam characteristics to compensate for the modification of the coverage area. The at least one WTRU forms a return beam that is concentrated on the antenna of the base station based on the instructions. The beam characteristics may include at least one of beam dimensions, power level, data rate, and encoding.

In yet another embodiment, the present invention is related to a hybrid beamforming smart antenna system and method for transmitting and receiving communications between at least one base station and a plurality of WTRUs by forming a plurality of three-dimensional control channel beams directed towards one or more hot-spots used by a plurality of WTRUs with different QoS requirements. The system comprises means for generating and adjusting beamwidths of the plurality of three-dimensional control channel beams, an antenna for transmitting and receiving signals within at least one three-dimensional control channel beam, means for defining a plurality of beamforming types in a beamforming type set B={B₁,B₂, . . . B_{N}}, wherein the beamforming width is Bₖ>Bₗ; if k<l and each WTRU is assigned to one of the beamforming types within the beamforming type set B, means for defining a beamforming cluster as Cⁱ where i identifies each cluster, and every cluster has at least one WTRU therein, and means for defining the total power constraint P in the system as

$$P = {\sum }_{j ∈ {C}_{i}} {\sum }_{i ∈ {B}_{i}} {P}_{j}^{{B}_{i}} ,$$

wherein (i) for each new WTRU i that enters the system, qᵢ=QoS(i), gᵢ=location(i) and mᵢ=mobility(i), and (ii) QoS and mobility are functions of WTRU QoS, location and mobility such that, if gᵢεCⱼ, qᵢ≦γ and |mᵢ=mᵢ|≦δ, then WTRU i is assigned to cluster j, where γ is a QoS threshold and δ is a mobility delta threshold in cluster j.

In yet another embodiment, the present invention is related to a method and apparatus for managing hot-zones or hot-spots, (i.e., designated high volume user coverage areas). Each of a plurality of WTRUs, which are served by a base station of a network cell, use a formed beam based on one or more beam characteristics. The base station uses at least one antenna to concentrate transmission and reception resources therein on at least one high volume user coverage area to serve the WTRUs. When the base station modifies the coverage area, the base station instructs the WTRUs to change their beam characteristics to compensate for the modification of the coverage area. The WTRU then forms a return beam that is concentrated on the antenna of the base station. The beam characteristics may include at least one of beam dimensions, power level, data rate, and encoding.

In yet another embodiment, a smart antenna is used to locate and provide information associated with the source of a signal, such as for reporting emergency location information which includes both azimuth and elevation information.

In yet another embodiment, hot-zones and hot-spots are managed by making use of both horizontal and vertical position information available from a smart antenna.

In yet another embodiment, networks nodes in a mesh type network make use of the vertical beam angle information from a smart antenna, in addition to the horizontal angle information, to more precisely direct their signals to other nodes, and reduce interference.

### BRIEF DESCRIPTION OF THE DRAWINGS

A more detailed understanding of the invention may be had from the following description, given by way of example and to be understood in conjunction with the accompanying drawings wherein:

FIG. 1 is a prior art common channel coverage scheme between a primary station and several WTRUs with four two-dimensional overlapping wide beams.

FIG. 2 is a prior art scheme of two-dimensional downlink dedicated beams between a primary station and several WTRUs using dedicated beams;

FIG. 3 is a prior art scheme of rotating two-dimensional common channel beam emanating from a primary station;

FIG. 4 is a prior art two-dimensional beam configuration for known uneven distribution of WTRUs;

FIG. 5 is a prior art two-dimensional beam configuration having beam width adjusted for traffic type;

FIG. 6 shows an exemplary conventional wireless smart antenna communication system using adaptive beam forming;

FIG. 7 illustrates a plurality of hot-spots co-existing in a conventional wireless communication system;

FIG. 8 illustrates subscribers having different QoS requests within the same hot-spot of a conventional wireless communication system;

FIG. 9 shows sectors created by a conventional smart antenna in a coverage area extending from a base station;

FIG. 10 shows a conventional smart antenna defining a hot zone only in a horizontal orientation;

FIG. 11 shows sectors in a coverage area defined by angular slices and distance in accordance with the present invention;

FIG. 12 shows a smart antenna defining a hot zone in a horizontal and vertical orientation in accordance with the present invention;

FIG. 13 illustrates hot-spot management from the perspective of a wireless transmit/receive unit in accordance with one embodiment of the present invention;

FIG. 14 illustrates an example of beams providing overall coverage via their overlap in accordance with another embodiment of the present invention; and

FIG. 15 illustrates an example of a beamforming allocation of a plurality of clusters formed by a hybrid beamforming antenna system in accordance with another embodiment of the present invention.

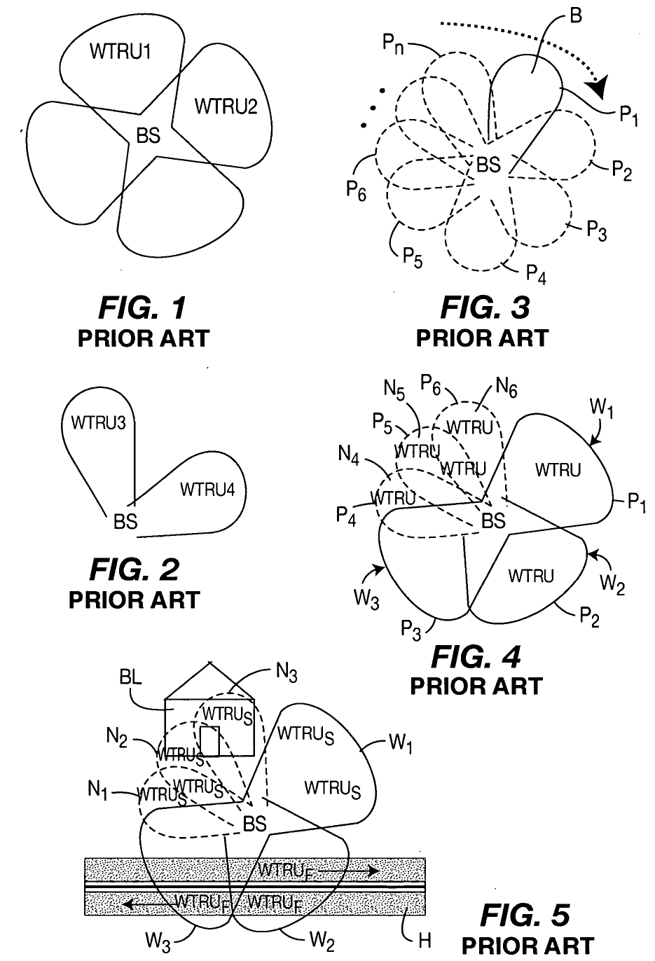

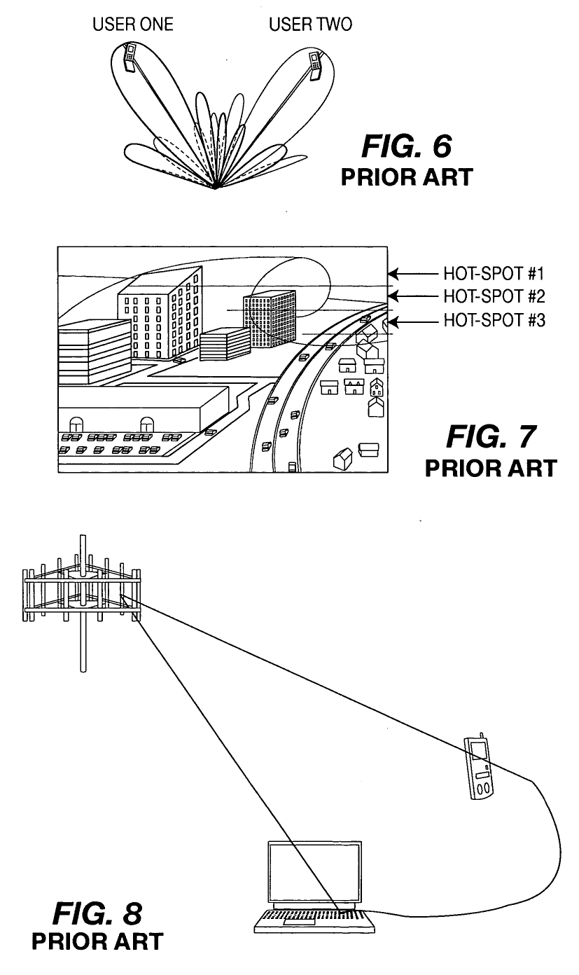

### DETAILED DESCRIPTION OF THE PREFERRED EMBODIMENTS

Hereafter, the terminology “WTRU” includes but is not limited to a user equipment (UE), a mobile station, a fixed or mobile subscriber unit, a pager, or any other type of device capable of operating in a wireless environment.

When referred to hereafter, the terminology “base station” includes but is not limited to a Node-B, a site controller, an access point (AP) or any other type of interfacing device in a wireless environment.

The present invention may be incorporated into a wireless communication system, a WTRU and a base station. The features of the present invention may be incorporated into an integrated circuit (IC) or be configured in a circuit comprising a multitude of interconnecting components.

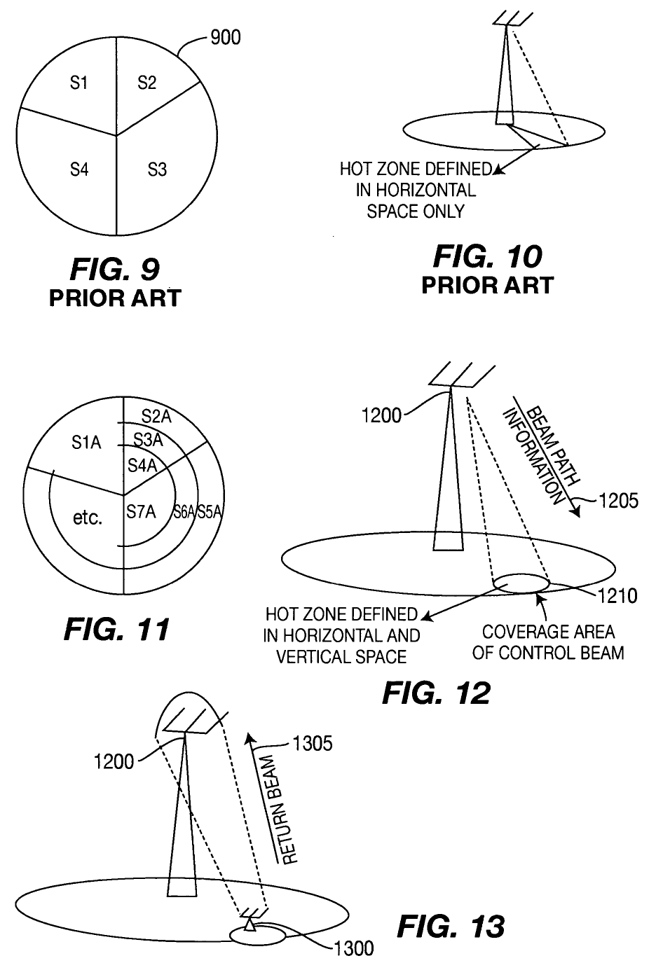

In one embodiment, vertical beam angle information available from a smart antenna is used in sectorization and cell planning. Unlike the sectors S1, S2, S3, S4, shown in FIG. 9, sectors are created in a cellular coverage area to reduce interference and to help cell planning by including vertical beam angle information, in addition to the horizontal angle information. This way, sectors can be specified to be at or within a particular distance from the base station, as shown by sectors S1A, S2A, S3A, S4A, S5A, S6A, S7A in FIG. 11. This adds another dimension to sectorization and makes management of users and interference more effective, resulting in higher capacity and lower power consumption.

In another embodiment, elevation information that is available as part of smart antenna processing is used for emergency location detection/reporting. According to the present invention, location of a subscriber is determined not only by the horizontal direction of the signal but also its vertical position. Therefore, the location of a user is determined in a three-dimensional space rather than a two dimensional map only. By taking into consideration a signal arriving from the vertical orientation to identify a location, a more precise measurement is carried out. This elevation information can be extracted from the smart antenna configuration being used and reported as part of location information. This type of precise location information is especially important when a user, who may potentially be in an emergency situation, is on a particular floor of a building, or in the basement, or say trapped under deep rubble, etc.

Smart antennas are aware of the angle at which a signal arrives and often make use of this information to either target a transmit signal better, or to help in location detection. In either case though, only the azimuth (horizontal position) information is used in prior art systems. It is also possible for a smart antenna to be aware of the elevation (vertical position). There are occasions when the exact horizontal and vertical location of a signal source of a user is of importance, e.g., when the user is on a particular floor of a building. This type of information is often very critical in getting emergency help to someone in distress. Both horizontal and vertical location information from the smart antenna are used in detecting and reporting location information.

In another embodiment, the present invention provides definition, identification, and management of hot-zones and hot-spots making use of both horizontal and vertical position information available from smart antennas, as shown in FIG. 8. Vertical position information that is available from smart antennas is used to define hot spots and zones in a more precise manner as small areas of coverage rather than slices.

Smart antennas can detect and report angle of arrival for received signals. In the current state of the art, typically horizontal orientation of the beam is detected and used in either forming the appropriate beam in the other direction or in determining the subscriber's location. This information is also used in defining hot spots and hot zones in coverage area so that areas with high concentration of users can be served with appropriate resources. This way, a hot zone is defined as an angular slice in the area that the smart antenna serves.

In addition to the horizontal position of the beam, smart antennas can detect the vertical location of the beam also. This added information and ability to direct signals specifically to a range of vertical range can be useful in defining hot spots and hot zones in a more precise manner. Accordingly, the vertical angle (position) information is used along with the horizontal angle information to define hot spots and zones, serve them, and manage them.

In another embodiment, vertical beam angle information available from a smart antenna is used in establishing and maintaining links between nodes in a mesh type network. In a mesh type network, each node connects with one or more other nodes and transfers information back and forth. It is desirable to establish these communication links in a manner that does not create undue interference for the other nodes. As a result, interference to other nodes and users will be reduced and overall power in the network will be reduced.

In mesh type networks, nodes communicate between each other in a dynamically changing traffic pattern. Each node connects with one or more nodes at a time and the nodes that are connected can change from time to time. In this environment, it is important to reduce the amount of interference and thereby reduce the overall power consumption as well. The nodes are equipped with smart antennas that use both horizontal and vertical beam angles to form beams that are more appropriately directed from one node to another. In absence of the vertical beam angle information, transmissions between nodes extend in angular slices of coverage and they interfere with other nodes. Using vertical beam angle information results in more precise positioning of beams and reduces overall power consumption.

As shown in FIG. 12, a network cell with a smart antenna 1200 is shown concentrating its transmission and reception beams 1205 on a hot spot area 1210 defined in horizontal and vertical space. This hot spot area 1210 may have a high concentration of WTRUs, some of which may require higher data rates or sufficient signal concentration to penetrate a structure.

As shown in FIG. 13, a WTRU 1300 in accordance with the present invention has a sophisticated processing capability such it can automatically detect the direction of an incoming signal, and form a return beam 1305 to the infrastructure 1200, with the pattern formed in azimuth and elevation so that its power is concentrated on the infrastructure antenna. This beam would be used for both the reception and transmission of the RF signal. Use of such beams would improve this communication link's signal leading to the usual desirable benefits of improved coverage, capacity, and data rates. The WTRU 1300 also benefits by needing less transmission power, which for battery powered and/or heat dissipation limited devices is quite important.

To reduce the processing needs of the WTRU or more quickly have its beam forming reach a near ideal state, the infrastructure can send detailed information to the WTRU as to the way its beamforming should operate. This information could include beam dimensions (width and height), power level, and angle information for azimuth and elevation. If the WTRU knows its orientation to the Earth or the infrastructure, all of the angle information can be used to orientate its beams. Less sophisticated devices however may only know, or assume, (e.g., computers are nominally setup with antennas in vertical orientation), that the elevation information is useful. The WTRU can use the subset of the information that supports a useable initial link, and then adjust the beam in angle, dimensions, and power as measurements and/or feedback from the infrastructure leads it.

The WTRU may retain information about its communication with the infrastructure after a link is terminated. If the WTRU has not moved, or detected movement when another connection is required, this information can be used to seed the initial link. It is possible however that the infrastructure has modified its hot spot coverage, making the prior information inadequate for connecting. The WTRU can then revert to a broad contact strategy.

During existing links, the infrastructure may find it necessary to change its hot spot coverage. Lunch breaks, the start or end of the work day, or other triggers may cause significant changes in their deployment for instance. The WTRU may therefore be instructed to change its beam characteristics to compensate for the change. The change could be to tighten or loosen the beams dimensions, change power level proportionally to other changes, data rates, encoding characteristics, or the like.

The ability of the WTRU to direct its reception and transmission to a cell site in both horizontal and vertical orientation can be extended to macro diversity as well. In this case, the WTRU can form and direct beams to two or more cell sites at the same time. As previously mentioned, horizontal and vertical orientation of these beams may be determined by the WTRU, or transmitted to the WTRU from the base station, or both. The advantage gained once again is that the amount of interference created to the rest of the system is reduced. In the special case of time division duplex (TDD) systems, this approach overcomes the WTRU-to-WTRU interference problem that is encountered.

The application of the WTRU smart antenna concept to a wireless local area network (WLAN) may especially be beneficial. In many WLAN applications, access points (APs) operate on one frequency band and it is not uncommon for APs in close proximity to be operating on the same frequency band. In these type situations, WTRU communicating with one AP will create undue interference to the other APs. By using smart antennas at the WTRU, this interference can be substantially reduced. Since APs are not necessarily installed at the same vertical location, the ability of the WTRU to direct signals in both horizontal and vertical space is especially important.

WLANs are also often deployed within buildings. Their deployment within a floor area may not allow much leeway for elevation adjustment within the floor, but the existence of floors above or below the deployed unit makes elevation use possible, and in some cases necessary to penetration the intervening building structure. Since it is difficult to create an antenna structure that will have a full spherical controllable beam to address all possibilities, the WTRU and its antenna structure, or a separable antenna structure from the main electronics, may be deployed in various orientations to allow coverage of the desire areas. The WTRU may also be fitted attached or deployable with multiple antenna structures to provide the necessary coverage.

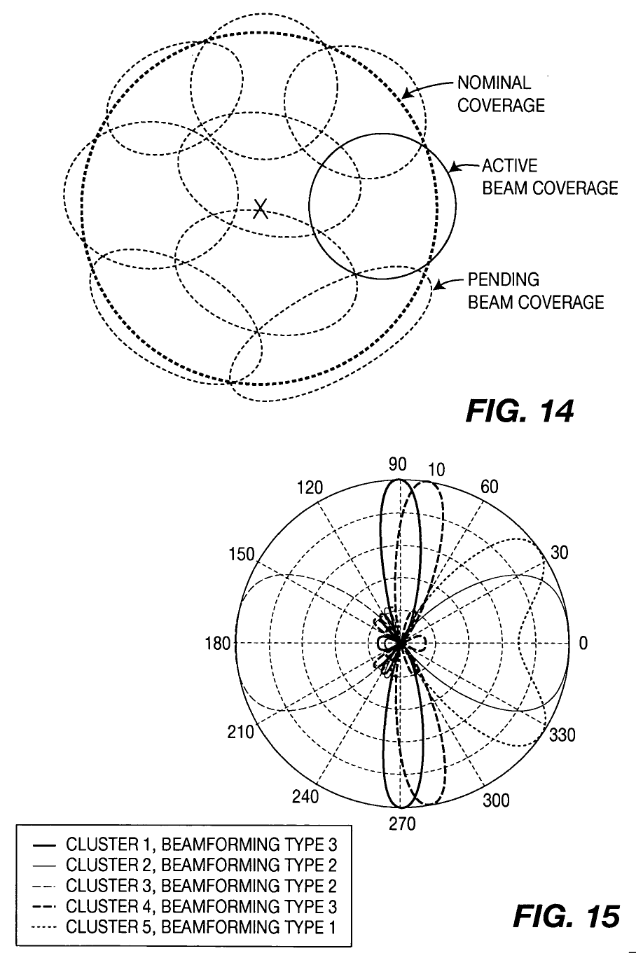

FIG. 14 illustrates one embodiment in which beam coverage utilizes beam forming with adjustments in bore sight and beam width in both azimuth and elevation. The view is looking down towards the surface of the Earth. The outlines of the various shapes are the nominal coverage from each beam at the surface. The nominal coverage is the overall area being supported by a base station. The active beam coverage is an existing region being supported. The pending beam coverage is the next area to be supported. The various oval-like shapes are the beam nominal coverage areas.

FIG. 14 is applicable to both the control and data phases of communication. Whether the coverage is static or swept is dependant on the function being performed. In general, control will tend to be more transitory, while data will be more static. Data is also more likely to require multiple beams being used simultaneously to support spatial reuse of available frequency resources.

FIG. 14 is for illustrative purposes only. The actual coverage area for each beam will tend to be very irregular. The effective coverage area for each beam is actually also determined by the receiver and transmitter characteristics at both the infrastructure site and the individual user devices. Encoding, interference, scattering, weather, and all the other well known things that affect RF communication will affect and cause periodic variations in the coverage area.

FIG. 14 shows signal contours on a planar surface. In real situations the surface will often not be planar. Instead, the signal contour not near the Earth's surface will often be the definer of the coverage volume as opposed to area. To significantly penetrate structures, such as buildings, a beam focus on the structure, or focus in a fashion that causes significant scattering into the structure will be required. In high scatter environments, such as dense building areas often referred to as “Manhattan distributions,” the coverage from a beam may actually have a number of discontinuous coverage volumes.

As per conventional wireless communication systems, the various beams can be numbered. The various sequencing techniques illustrated for the azimuth-only version, can likewise be applied to the three-dimension adjusted beams and their volume coverage. Besides adjusting the beam's power contour, symbol timing adjusting may also be used to improve performance. This is especially important in beam overlap volumes and ground level areas.

While the present invention of this disclosure illustrates the invention by generating a single beam in a time period, a more sophisticated implementation could generate multiple beams covering a number of areas. The primary benefit is the ability to provide overall coverage in a more timely fashion. While in general such multiple beams could overlap their coverage volumes, there is a benefit to generating them such that they do not do so. This benefit is less interference between the coverage volumes. Both control and data communications benefit from sweeping beam coverage, and varying existence of simultaneous coverage by multiple beams. Control will be biased towards fewer beams and more rapid sweeping, while data will tend to be supported by more beams which are slower sweeping or actually static in coverage.

While this disclosure talks about azimuth and elevation, which are nominally associated with horizontal and vertical orientation to the Earth, it should be recognized that this invention is applicable to rotation in either or both the discussed reference planes.

Although desirable, it is not necessary that the planes be completely orthogonal to each other. In another embodiment, a hybrid smart antenna system combines the advantages of both an adaptive smart antenna and fixed beamforming configurations. Hybrid beams are configured and deployed. Beams with adaptive capability to track WTRUs and beams with fixed layout to cover wide area of service. Furthermore, beams with different sizes or beamwidth co-exist in the antenna system to provide improved service such as to cover a hot-spot or to track a cluster of WTRUs, (i.e., users) of different group size or angular separation in both azimuth and elevation. The beams are managed by assigning and/or reassigning beams to WTRUs to increase system capacity, provide better QoS and reduce interference more efficiently than prior art smart antenna systems.

In one embodiment, the present invention combines the advantages of both smart antennas and fixed beamforming into a hybrid beamforming system that forms a plurality of three-dimensional control channel beams directed towards one or more hot-spots used by a plurality of WTRUs with different QoS requirements. The beams have different beamforming characteristics and cover different clusters. For example, the beams may include fixed beams, tracking, (i.e., adaptive), beams that have the ability to track WTRUs in motion, and wide or narrow beams with various beamwidths in both azimuth and elevation that cover a cluster of WTRUs of different size, either stationary or in motion. The hybrid system can support WTRUs with various characteristics such as speeds, range of activities in both azimuth and elevation, QoS, or the like.

For example, a smart antenna may lose track of high speed WTRUs. Thus, the system may assign the WTRUs to fixed beams that have wider coverage. Alternatively, a WTRU may be assigned to a tracking beam, rather than a fixed beam, when a high QoS is demanded.

Assume that there are several types of beamforming existing in one wireless communication system including a plurality of WTRUs, designated as beamforming type set B={B₁,B₂, . . . B_{N}}. Beamforming types are mainly characterized by the beamwidth, power, coverage, azimuth and elevation, or the like. Other characteristics can also be used to define the beamforming types such as fixed, switched, or adaptive beamforming, or the like. For example, one beamforming type may be a wider fixed beam with large coverage and higher power. Another beamforming type may be an adaptive narrow beam with lower power, narrow coverage in azimuth and elevation, and with mobility tracking ability.

Also assume that the beamforming width is Bₖ>Bₗ; if k<l and each WTRU will be assigned to one of the beamforming types within the beamforming type set B. In the wireless communication system, a beamforming cluster is defined as Cⁱ where i identifies each cluster, and every cluster has at least one WTRU therein. The beamforming clusters are mainly characterized by the geography, locations, azimuth and elevation of the WTRUs. For example, a hot-spot itself can form a beamforming cluster. A group of people carrying WTRUs in the elevator can naturally be categorized into the same beamforming cluster.

The beamforming clusters can merge or be divided. Two beamforming clusters can merge into one or one beamforming cluster can divide into two. Based on the characteristics of the WTRUs, the WTRUs can be categorized into one of the beamforming clusters. Based on the services requested, the WTRUs can be assigned to one or more of the beamforming types. The assignment and reassignment of the WTRUs to beamforming clusters and beamforming types optimizes the system performance.

The WTRUs may be assigned or reassigned across beamforming clusters and beamforming types, provided the total power constraint of the system is satisfied. The total power allocated to the WTRUs in different beamforming types or beamforming clusters may not exceed the total allowable power of the systems. The total power constraint in one cellular system is defined by Equation (1) as follows:

$$P = {\sum }_{j ∈ {C}_{i}} {\sum }_{i ∈ {B}_{i}} {P}_{j}^{{B}_{i}} . \qquad Equation ( 1 )$$

A beamforming type assignment for each WTRU will bear with the following algorithm: for each new WTRU i that enters the system, take qⁱ=QoS(i), gᵢ=location(i) and mᵢ=mobility(i). If a WTRU is nearby, a beamforming cluster and its speed is approximately the same to the speed of that WTRU's cluster and moves in the same direction in azimuth and elevation. The WTRU is then included in that beamforming cluster, (i.e., if gᵢεCⱼ and |mᵢ−mⱼ|≦δ, then assign WTRU i to cluster j). δ is a mobility delta threshold in cluster j. Denote γ a QoS threshold. If qᵢ>γ, then WTRU i is assigned to a beamforming type that high QoS demanding. On the other hand, if qᵢ<γ, then WTRU i is assigned to a beamforming type that is low QoS demanding. The QoS threshold may have multiple values, or the QoS may have multiple thresholds to further define different levels of QoS demands. For example, if qᵢ>γ, then the narrow beamwidth is assigned, (i.e., the higher BₖεB).

When a WTRU is moving at high speed, a wider beam is assigned. The assignment of high speed device to wider beam has the advantages of avoiding losing the track of the WTRU at high speed and avoiding too many handovers that usually require heavy signaling to accomplish the tasks which increase the overhead of the data transmission. If mᵢ>σ where σ is the speed threshold, then assign the wider beamwidth, (i.e., the lower BₖεB), if the WTRUs move perpendicular to the direction of beam. There may not be an assignment of wider beam if the WTRUs move at higher speed in parallel to the direction of the beam.

The systems may have multiple speed thresholds to determine the proper beamwidth of the beams, and the systems can have beams of different beamwidths and beamforming types. The total power shall be smaller than the power constraint when adding beams or reassigning the beamforming types. If the power constraint of the systems is violated, the WTRU can not be assigned or should be reassigned to the beamforming type with lower required power such that the power of all WTRUs does not exceed the total allowable power of the systems.

A WTRU iεCⱼ can be reassigned to different beamforming type BₖεB or a different cluster Cⱼ due to a QoS, mobility change, location change, or others that trigger the reassignment of the beamforming clusters or beamforming types. FIG. 15 is a snap shot of a beamforming allocation example of a plurality of clusters formed by a hybrid beamforming antenna system in accordance with another embodiment of the present invention.

FIG. 15 illustrates a plurality of three-dimensional control channel beams formed by an exemplary hybrid beamforming system that employs different beamforming types with different beamwidths and cover different beamforming clusters. Each three-dimensional control channel beam belongs to one of the beamforming types and is used to cover one of a plurality of beamforming cluster.

A first beam shown in FIG. 15 uses beamforming type 3 with a narrow beamwidth and is used to cover beamforming cluster 1 in the direction of 90 degrees. Due to the mobility of beamforming cluster 1, the beamforming cluster 1 changes its location, (i.e., off by 10 degrees clockwise). Furthermore, the beamforming cluster also accommodates some new WTRUs, thus becomes beamforming cluster 4. The first beam serves as a tracking beam whereby it is steered to cover the beamforming cluster 4, (formerly beamforming cluster 1), but still uses beamforming type 3, (an adaptive narrow beamforming type with a tracking ability).

A second beam shown in FIG. 15 uses beamforming type 2 with a moderate beamwidth centered in the direction of 0 degrees and covers the beamforming cluster 2.

A third beam shown in FIG. 15 uses beamforming type 2 with a moderate beamwidth centered in the direction of 180 degrees and covers the beamforming cluster 3.

A fourth beam shown in FIG. 15 uses beamforming type 1 with a wide beamwidth, (wider than beamforming type 2), centered in the direction of 0 degrees and covers the beamforming cluster 5.

While the present invention has been described in terms of the preferred embodiment, other variations which are within the scope of the invention as outlined in the claims below will be apparent to those skilled in the art.

1. A wireless communication system for transmitting and receiving communications between at least one base station and at least one wireless transmit/receive unit (WTRU) by providing one or more three-dimensional control channel beams, the system comprising:
(a) means for generating and shaping at least one three-dimensional control channel beam;
(b) an antenna for transmitting and receiving signals within the at least one three-dimensional control channel beam;
(c) means for directing the at least one three-dimensional control channel beam to cover a particular coverage area, wherein beam forming is utilized to adjust bore sight and beam width of the at least one three-dimensional control channel beam in both azimuth and elevation; and
(d) means for identifying the at least one three-dimensional control channel beam.

2. The system of claim 1 wherein the antenna receives a communication.

3. The system of claim 1 wherein the antenna transmits a communication.

4. The system of claim 1 wherein the means for generating and shaping shapes the at least one three-dimensional control channel beam into one of a plurality of selectable widths, from a wide width to a narrow width.

5. The system of claim 1 wherein the coverage area coincides with one or more sectors of a cell.

6. The system of claim 5 wherein the cell sectors are different sizes and the generating and shaping means shapes the three-dimensional control channel beam to cover the cell sectors, the sectors being identified by the means for identifying.

7. The system of claim 1 wherein the means for generating and shaping shapes a plurality of three-dimensional control channel beams, and the means for directing selectively directs the shaped three-dimensional control channel beams in azimuth and elevation in a predetermined consecutive sequence.

8. The system of claim 1 wherein the means for generating and shaping shapes a plurality of three-dimensional control channel beams, and the means for directing selectively directs the shaped three-dimensional control channel beams in azimuth and elevation in a predetermined non-consecutive sequence.

9. The system of claim 8 wherein the non-consecutive sequence causes the means for directing to selectively direct the beam toward one of azimuth and elevation more frequently than the other one of azimuth and elevation.

10. The system of claim 8 wherein the non-consecutive sequence causes the means for directing to selectively direct the beam toward one of azimuth and elevation for a longer duration than the other one of azimuth and elevation.

11. The system of claim 1 wherein the means for identifying the three-dimensional control channel beam includes means for providing a unique identifier for the three-dimensional control channel beam.

12. The system of claim 1 wherein the means for identifying the three-dimensional control channel beam includes means for transmitting a time mark to the WTRU, whereby the WTRU returns an indication of the received time mark, as detected by the WTRU, to the base station.

13. The system of claim 1 wherein the means for identifying the three-dimensional control channel beam includes a time reference accessed by both the WTRU and the base station.

14. The system of claim 1 further comprising a position reporting circuit to provide a position location of the WTRU, the base station using the position location to identify at least one beam direction for the WTRU.

15. In a wireless communication system for transmitting and receiving communications between at least one base station and at least one wireless transmit/receive unit (WTRU) by providing one or more three-dimensional control beams, a method comprising:
(a) generating and shaping at least one three-dimensional control channel beam;
(b) transmitting and receiving signals within the at least one three-dimensional control channel beam;
(c) directing the at least one three-dimensional control channel beam to cover a particular coverage area, wherein beam forming is utilized by adjusting bore sight and beam width of the at least one three-dimensional control channel beam in both azimuth and elevation; and
(d) identifying the at least one three-dimensional control channel beam.

16. The method of claim 15 wherein step (a) further comprises shaping the three-dimensional control channel beam into one of a plurality of selectable widths, from a wide width to a narrow width.

17. The method of claim 15 wherein the coverage area coincides with one or more sectors of a cell.

18. The method of claim 15 wherein the cell sectors are different sizes.

19. The method of claim 18 wherein step (a) further comprises shaping the three-dimensional control channel beam to cover the cell sectors.

20. The method of claim 18 wherein step (d) further comprises identifying the sectors.

21. The method of claim 15 wherein a plurality of three-dimensional control channel beams are generated and shaped and directed in azimuth and elevation in a predetermined consecutive sequence.

22. The method of claim 15 wherein a plurality of three-dimensional control channel beams are generated and shaped and directed in azimuth and elevation in a predetermined non-consecutive sequence.

23. The method of claim 22 wherein the non-consecutive sequence causes the three-dimensional control channel beam to be selectively directed toward one of azimuth and elevation more frequently than the other one of azimuth and elevation.

24. The method of claim 22 wherein the non-consecutive sequence causes the three-dimensional control beam to be selectively directed toward one of azimuth and elevation for a longer duration than the other one of azimuth and elevation.

25. The method of claim 15 wherein step (d) further comprises providing a unique identifier for the three-dimensional control channel beam.

26. The method of claim 15 wherein step (d) further comprises:
(d1) identifying the three-dimensional control channel beam by transmitting a time mark to the WTRU; and
(d2) the WTRU receiving the time mark and returning an indication of the received time mark, as detected by the WTRU, to the base station.

27. The method of claim 15 wherein step (d) further comprises providing a time reference accessed by both the WTRU and the base station.

28. The method of claim 15 further comprising providing a position location of the WTRU, the base station using the position location to identify at least one beam direction for the WTRU.

29. In a wireless communication system including a plurality of wireless transmit/receive units (WTRUs) which communicate with a base station using a three-dimensional control channel beam formed based on one or more beam characteristics, the base station having at least one antenna, a method of compensating for changes in one or more designated high volume user coverage areas served by the base station, the method comprising:
(a) the base station using the antenna to concentrate transmission and reception resources therein on at least one high volume user coverage area for serving users of the WTRUs;
(b) the base station modifying the coverage area;
(c) the base station conveying instructions to at least one of the WTRUs to change its beam characteristics to compensate for the modification of the coverage area; and
(d) the at least one WTRU forming a return beam that is concentrated on the antenna of the base station based on the instructions.

30. The method of claim 29 wherein the beam characteristics include at least one of beam dimensions, power level, data rate, and encoding.

31. A wireless communication system for compensating for changes in one or more designated high volume user coverage areas, the system comprising:
(a) a base station; and
(b) a plurality of wireless transmit/receive units (WTRUs) which communicate with the base station using a three-dimensional control channel beam formed based on one or more beam characteristics, the base station having at least one antenna, wherein:
(i) the base station uses the antenna to concentrate transmission and reception resources therein on at least one high volume user coverage area for serving users of the WTRUs;
(ii) the base station modifies the coverage area;
(iii) the base station conveys instructions to at least one of the WTRUs to change its beam characteristics to compensate for the modification of the coverage area; and
(iv) the at least one WTRU forms a return beam that is concentrated on the antenna of the base station based on the instructions.

32. The method of claim 31 wherein the beam characteristics include at least one of beam dimensions, power level, data rate, and encoding.

33. A hybrid beamforming antenna system for transmitting and receiving communications between at least one base station and a plurality of wireless transmit/receive units (WTRUs) by forming a plurality of three-dimensional control channel beams directed towards one or more coverage areas that serve a plurality of WTRUs with different quality of service (QoS) requirements, the system comprising:
(a) means for generating and adjusting beamwidths of the plurality of three-dimensional control channel beams;
(b) an antenna for transmitting and receiving signals within at least one three-dimensional control channel beam;
(c) means for defining a plurality of beamforming types in a beamforming type set B={B₁,B₂, . . . B_{N}}, wherein the beamforming width is Bₖ>Bₗ; if k<l and each WTRU is assigned to one of the beamforming types within the beamforming type set B;
(d) means for defining a beamforming cluster as Cⁱ where i identifies each cluster, and every cluster has at least one WTRU therein; and
(e) means for defining the total power constraint P in the system as
$$P = {\sum }_{j ∈ {C}_{i}} {\sum }_{i ∈ {B}_{i}} {P}_{j}^{{B}_{i}} ,$$
wherein (i) for each new WTRU i that enters the system, qᵢ=QoS(i), gᵢ=location(i) and mᵢ=mobility(i), and (ii) QoS and mobility are functions of WTRU QoS, location and mobility such that, if gᵢεCⱼ, qᵢ≦γ and |mᵢ−mⱼ|≦δ, then WTRU i is assigned to cluster j, where γ is a QoS threshold and δ is a mobility delta threshold in cluster j.

34. In a hybrid beamforming antenna system for transmitting and receiving communications between at least one base station and a plurality of wireless transmit/receive units (WTRUs) by forming a plurality of three-dimensional control channel beams directed towards one or more coverage areas that serve a plurality of WTRUs with different quality of service (QoS) requirements, a method comprising:
(a) generating and adjusting beamwidths of the plurality of three-dimensional control channel beams;
(b) transmitting and receiving signals within at least one three-dimensional control channel beam;
(c) defining a plurality of beamforming types in a beamforming type set B={B₁,B₂, . . . B_{N}}, wherein the beamforming width is Bₖ>Bₗ; if k<l and each WTRU is assigned to one of the beamforming types within the beamforming type set B;
(d) defining a beamforming cluster as Cⁱ where i identifies each cluster, and every cluster has at least one WTRU therein; and
(e) means for defining the total power constraint P in the system as
$$P = {\sum }_{j ∈ {C}_{i}} {\sum }_{i ∈ {B}_{i}} {P}_{j}^{{B}_{i}} ,$$
wherein (i) for each new WTRU i that enters the system, qᵢ=QoS(i), gᵢ=location(i) and mᵢ=mobility(i), and (ii) QoS and mobility are functions of WTRU QoS, location and mobility such that, if gᵢεCⱼ, qᵢ≦γ and |mᵢ−mⱼ|≦δ, then WTRU i is assigned to cluster j, where γ is a QoS threshold and δ is a mobility delta threshold in cluster j.

35. A wireless communication system including at least one base station in communication with a plurality of WTRUs having different quality of service (QoS) requirements, wherein the at least one base station forms a plurality of three-dimensional control channel beams directed towards one or more coverage areas that serve the WTRUs, wherein the at least one base station forms and assigns a particular type of beam to each one of the WTRUs based on the respective WTRU's QoS requirement, and assigns each of the WTRUs to at least one of a plurality of beamforming clusters.

36. The system of claim 35 wherein the particular type of beam is characterized by at least one of beamwidth, power, coverage, azimuth and elevation.

37. The system of claim 36 wherein the particular type of beam is one of a fixed beam, a switched beam and an adaptive beam.

38. The system of claim 36 wherein the coverage characteristic is one of large coverage and narrow coverage.

39. The system of claim 36 wherein the power characteristic is one of high power and low power.

40. The system of claim 36 wherein the beamwidth characteristic is one of narrow beamwidth and wide beamwidth.

41. The system of claim 40 wherein the beamwidth characteristic is determined based on the velocity of the WTRU.

42. In a wireless communication system including at least one base station in communication with a plurality of WTRUs having different quality of service (QoS) requirements, a method comprising:
(a) the at least one base station forming a plurality of three-dimensional control channel beams directed towards one or more coverage areas that serve the WTRUs;
(b) the at least one base station forming and assigning a particular type of beam to each one of the WTRUs based on the respective WTRU's QoS requirement; and
(c) the at least one base station assigning each of the WTRUs to at least one of a plurality of beamforming clusters.

43. The method of claim 42 wherein the particular type of beam is characterized by at least one of beamwidth, power, coverage, azimuth and elevation.

44. The method of claim 43 wherein the particular type of beam is one of a fixed beam, a switched beam and an adaptive beam.

45. The method of claim 43 wherein the coverage characteristic is one of large coverage and narrow coverage.

46. The method of claim 43 wherein the power characteristic is one of high power and low power.

47. The method of claim 43 wherein the beamwidth characteristic is one of narrow beamwidth and wide beamwidth.

48. The method of claim 47 wherein the beamwidth characteristic is determined based on the velocity of the WTRU.

49. In a wireless communication system including a plurality of WTRUs having different quality of service (QoS) requirements, a base station comprising:
(a) means for forming a plurality of three-dimensional control channel beams directed towards one or more coverage areas that serve the WTRUs;
(b) means for forming and assigning a particular type of beam to each one of the WTRUs based on the respective WTRU's QoS requirement; and
(c) means for assigning each of the WTRUs to at least one of a plurality of beamforming clusters.

50. The base station of claim 49 wherein the particular type of beam is characterized by at least one of beamwidth, power, coverage, azimuth and elevation.

51. The base station of claim 50 wherein the particular type of beam is one of a fixed beam, a switched beam and an adaptive beam.

52. The base station of claim 50 wherein the coverage characteristic is one of large coverage and narrow coverage.

53. The base station of claim 50 wherein the power characteristic is one of high power and low power.

54. The base station of claim 50 wherein the beamwidth characteristic is one of narrow beamwidth and wide beamwidth.

55. The base station of claim 54 wherein the beamwidth characteristic is determined based on the velocity of the WTRU.

56. A wireless communication system for transmitting and receiving communications, the system comprising:
(a) at least one wireless transmit/receive unit (WTRU) including an antenna for forming at least one beam for transmission or reception; and
(b) a base station for sending detailed information to the WTRU instructing the WTRU how to form the at least one beam.

57. The system of claim 56 wherein the detailed information indicates the dimensions of the at least one beam.

58. The system of claim 57 wherein the dimensions are the width and height of the at least one beam.

59. The system of claim 56 wherein the detailed information indicates the power level of the at least one beam.

60. The system of claim 56 wherein the detailed information indicates the angle of the at least one beam for azimuth and elevation.

61. In a wireless communication system for transmitting and receiving communications, a wireless transmit/receive unit (WTRU) comprising:
(a) an antenna for forming at least one beam for transmission or reception; and
(b) a receiver for receiving detailed information from an external entity instructing the WTRU how to form the at least one beam.

62. The WTRU of claim 61 wherein the detailed information indicates the dimensions of the at least one beam.

63. The WTRU of claim 61 wherein the dimensions are the width and height of the at least one beam.

64. The WTRU of claim 61 wherein the detailed information indicates the power level of the at least one beam.

65. The WTRU of claim 61 wherein the detailed information indicates the angle of the at least one beam for azimuth and elevation.

66. In a wireless communication system including a base station that serves a plurality of wireless transmit/receive units (WTRUs), the base station comprising:
(a) an antenna; and
(b) a transmitter in communication with the antenna, the transmitter for sending beam forming instructions to one or more of the WTRUs, wherein the instructions indicate WTRU beam width and beam height, or WTRU beam angle for azimuth and elevation.

67. In a wireless communication network including a plurality of nodes, each node communicating with one or more of the other nodes over one or more communication links, a method comprising:
(a) equipping each of the nodes with a beam antenna that forms beams with both horizontal and vertical angles that are directed to another one of the nodes; and
(b) using information associated with the vertical beam angles to precisely position the beams and reduce inter-node interference and overall power consumption.

68. The method of claim 67 wherein the wireless communication network is a mesh type network

69. A wireless communication network comprising:
(a) a plurality of nodes, each node communicating with one or more of the other nodes over one or more communication links, wherein each node is equipped with a beam antenna that forms beams with both horizontal and vertical angles that are directed to another one of the nodes; and
(b) means for using information associated with the vertical beam angles to precisely position the beams and reduce inter-node interference and overall power consumption.

70. The network of claim 69 wherein the wireless communication network is a mesh type network

71. In a wireless communication system including a base station that serves a plurality of wireless transmit/receive units (WTRUs), the base station comprising:
(a) a beam forming antenna for locating the position of a particular one of the WTRUs in a three-dimensional space by providing both azimuth and elevation information based on signals received from the particular WTRU; and
(c) means for reporting emergency location information which includes both the azimuth and elevation information.

72. In a wireless communication system including a base station that serves a plurality of wireless transmit/receive units (WTRUs), a method comprising:
(a) locating the position of a particular one of the WTRUs in a three-dimensional space using a beam forming antenna that provides both azimuth and elevation information based on signals received from the particular WTRU; and
(b) reporting emergency location information associated with the particular WTRU, wherein the emergency location information includes both the azimuth and elevation information.
